(19) United States
(12) Patent Application Publication
(10) Pub. No.: US 2011/0141338 A1
(43) Pub. Date: Jun. 16, 2011

(54) CAMERA MODULE

(75) Inventors: Sang-Jin Lee, Suwon-si (KR); Seung-Man Oh, Suwon-si (KR)

(73) Assignee: SAMSUNG ELECTRO-MECHANICS CO., LTD.

(21) Appl. No.: 12/782,433

(22) Filed: May 18, 2010

(30) Foreign Application Priority Data
Dec. 16, 2009 (KR) 10-2009-0125369

(51) Int. Cl. H04N 5/33; G02B 7/02; H04N 5/30

(52) U.S. Cl. 348/342; 359/507; 348/335; 348/E05.085; 348/E05.09

(57) ABSTRACT

A camera module is disclosed. The camera module in accordance with an embodiment of the present invention includes a housing, which has a hollow part formed therein, a lens module, which has a lens and is installed in the hollow part of the housing in such a way that the lens module can reciprocate in a direction of an optical axis, and a foreign substance pan, which is coupled to the lens module and disposed to correspond to a gap formed between the housing and the lens module and in which foreign substance has passed through the gap being settled on the foreign substance pan. Therefore, since the entered foreign substance or the generated foreign substance is prevented from approaching an image sensor, etc., defect caused by the foreign substance can be prevented.

### CROSS-REFERENCE TO RELATED APPLICATIONS

This application claims the benefit of Korean Patent Application No. 10-2009-0125369, filed with the Korean Intellectual Property Office on Dec 16, 2009, the disclosure of which is incorporated herein by reference in its entirety.

### BACKGROUND

1. Technical Field

The present invention is related to a camera module.

2. Description of the Related Art

Today's mobile terminals, such as mobile phones, PDAs and mobile PCs, not only transmits short-text message or voice data but also take a photograph and transmit video data. In response to this trend, a camera module is typically installed in today's mobile terminals in order to enable photographing, video data transmission and video chatting.

Some camera modules have an auto-focusing function in order to automatically adjust the lens focus to the film or image sensor. In order to implement the auto-focusing function, the lens module has to move along the optical axis.

In order to move the lens module, a gap needs to be provided between the lens module and the housing. However, foreign substance, for example, dust, may enter the camera module through the gap. Moreover, foreign substance may be generated by the friction between the lens module and the housing.

Particularly, if the foreign substance is adhered to the image sensor or an infrared filter, defect may be formed on images.

### SUMMARY

The present invention provides a camera module that can prevent defect caused by foreign substance.

An aspect of the present invention provides a camera module. The camera module in accordance with an embodiment of the present invention can include a housing, which has a hollow part formed therein, a lens module, which has a lens and is installed in the hollow part of the housing in such a way that the lens module can reciprocate in a direction of an optical axis, and a foreign substance pan, which is coupled to the lens module and disposed to correspond to a gap formed between the housing and the lens module and in which foreign substance has passed through the gap being settled on the foreign substance pan.

The camera module can further include a first adhesive member, which is coupled to the foreign substance pan and disposed to correspond to the gap formed between the housing and the lens module.

A first foreign substance groove can be formed in the foreign substance pan to correspond to the gap formed between the housing and the lens module.

A flange can be formed in an inner wall of the hollow part of the housing to correspond to the foreign substance pan.

A second foreign substance groove can be formed in the housing to correspond to a gap formed between the housing and the foreign substance pan.

The camera module can further include a second adhesive member, which is coupled to the housing and disposed to correspond to a gap formed between the housing and the foreign substance pan.

The camera module can further include a driver, which moves the lens module in the direction of the optical axis.

The driver can include a voice coil actuator or a piezo actuator.

The camera module can further include an image sensor, which forms an image with a ray of light incident through the lens.

The camera module can further include an infrared filter, which is installed in the housing in such a way that the infrared filter is interposed between the image sensor and the lens module.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view of a camera module in accordance with an embodiment of the present invention.

FIG. 2 is a perspective view of a bobbin and a foreign substance pan in a camera module in accordance with an embodiment of the present invention.

FIG. 3 is a perspective view of a housing in a camera module in accordance with an embodiment of the present invention.

### DETAILED DESCRIPTION

The features and advantages of this invention will become apparent through the below drawings and description.

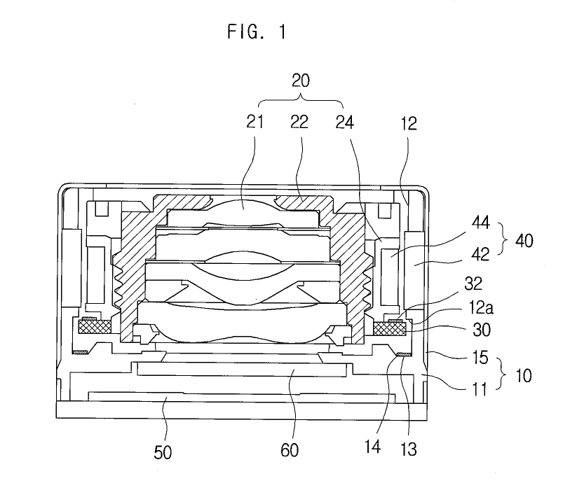

FIG. 1 is a cross-sectional view of a camera module in accordance with an embodiment of the present invention.

The camera module in accordance with an embodiment of the present invention includes a housing 10, a lens module 20 and a foreign substance pan 30. The camera module can further include a driver 40, an image sensor 50 and an infrared filter 60.

The housing 10 is where components needed for the camera module are housed and supported. For this, a hollow part 12 is formed in the housing 10. The housing 10 of the present embodiment has a cover housing 15 and a base housing 11, which is covered by the cover housing 15. The lens module 20, which will be described later, is mounted inside the hollow part 12 in such a way that the lens module 20 can be reciprocated inside the hollow part 12.

The lens module 20 is a part that is coupled to a lens 21 and reciprocated inside the hollow part 12 of the housing 10 along the optical axis in order to move the lens 21 when auto-focusing. In order to reciprocate the lens module 20 inside the hollow part 12, a gap needs to be formed between the housing 10 and the lens module 20. For this, a gap is formed between the housing 10 and the lens module 20.

As illustrated in FIG. 1, the lens module 20 of the present embodiment can include a lens barrel 22 that houses and supports the lens 21.

Furthermore, the camera module of the present embodiment can include the driver 40 that can move the lens module 20 in a direction of the optical axis. The driver 40 of the present embodiment is a voice coil actuator and includes a magnetic member 42, which is coupled to the housing 10, and a coil 44, which generates a magnetic field that interacts with the magnetic field of the magnetic member 42.

Specifically, the lens module 20 can include a bobbin 24 that is coupled to the lens barrel 22. Since the coil 44 is wound on an outer circumferential surface of the bobbin 24, the lens barrel 22 and the coil 44 become integrated into one body by the bobbin 24 so that the lens 21 can be moved by a magnetic force applied to the coil 44. In order to move the lens module 20 smoothly, a ball bearing (not shown) can be interposed between the bobbin 24 and the housing 10.

Then, the image sensor 50 is disposed on a bottom part of the lens module 20 in such a way that a ray of light incident through the lens 21 is formed to an image, and the infrared sensor 60 can be interposed between the image sensor 50 and the lens module 20. The infrared filter 60 of the present embodiment is mounted on and supported by the housing 10.

Although the present embodiment presents a voice coil actuator as the driver 40 to move the lens module 20, the present invention is not limited to this embodiment, and other various known actuators, for example, a piezo actuator, for camera module can be used as the driver 40.

The foreign substance pan 30 is a part that prevents foreign substance that entered the gap formed between the housing 10 and the lens module 20 or foreign substance that is generated by the friction between the housing 10 and the lens module 20 from approaching the image sensor 50 or the infrared filter 60. For this, the foreign substance pan 30 is coupled to the lens module 20 and disposed to correspond to the gap formed between the housing 10 and the lens module 20. Accordingly, the foreign substance passed through the gap between the housing 10 and the lens module 20 can be settled on the foreign substance pan 30. Therefore, since the entered foreign substance or the generated foreign substance is prevented from approaching the image sensor 50, etc., defect caused by the foreign substance can be prevented.

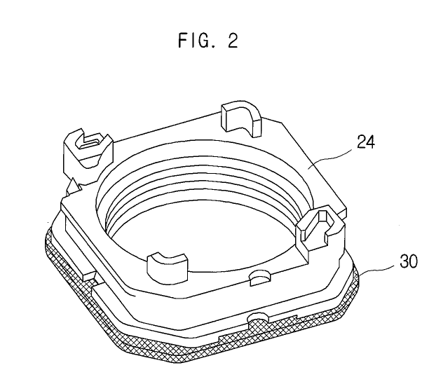

FIG. 2 is a perspective view of a bobbin and a foreign substance pan in a camera module in accordance with an embodiment of the present invention.

As illustrated in FIG. 2, the foreign substance pan 30 of the present embodiment is coupled to and protruded to the outside of a lower part of the bobbin 24 in order to be disposed underneath the gap formed between the housing 10 and the lens module 20. As a result, the foreign substance moving in the gap between the housing 10 and the lens module 20 can be settled on the foreign substance pan 30, and thus the foreign substance can be prevented from entering the inside.

Here, a first adhesive member 32 that is disposed corresponding to and underneath the gap between the housing 10 and the lens module 20 can be coupled to the foreign substance pan 30 such that the foreign substance placed on the foreign substance pan 30 can be prevented from escaping. The first adhesive member 32 fixes the foreign substance so that the foreign substance can be prevented from escaping from the foreign substance pan 30.

Furthermore, the foreign substance pan 30 can have a first foreign substance groove (not shown) corresponding to and underneath the gap between the housing 10 and the lens module 20 so that the foreign substance placed on the foreign substance pan 30 can be trapped.

A flange 12a can be formed in a depressed portion of an inner wall of the hollow part 12 of the housing 10 to correspond to the protruded shape of the foreign substance pan 30 so that the gap between the housing 10 and the lens module 20 does not form a straight line. Accordingly, the foreign substance falling through the gap between the housing 10 and the lens module 20 does not fall further when the foreign substance reaches a corner formed by the flange 12a and can be settled on the foreign substance pan 30.

In case there is foreign substance having entered the inside without being settled on the foreign substance pan 30, a second foreign substance groove 13 that is disposed corresponding to and underneath the gap between the housing 10 and the foreign substance pan 30 can be formed in the housing 10 in order to prevent the foreign substance from entering further.

Furthermore, a second adhesive member 14 that is disposed corresponding to and underneath the gap formed between the housing 10 and the foreign substance pan 30 can be coupled to the housing 10. The second adhesive member 14 fixes the foreign substance so that the foreign substance can be prevented from moving further to the inside.

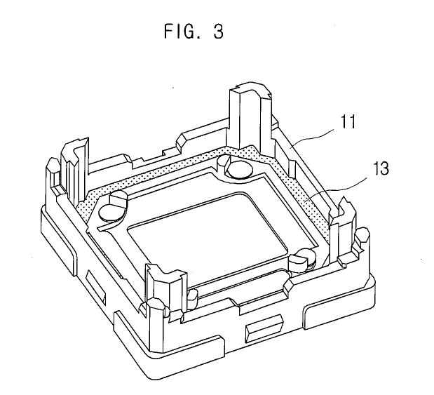

FIG. 3 is a perspective view of a housing in a camera module in accordance with an embodiment of the present invention.

As illustrated in FIG. 3, the second foreign substance groove 13 is formed along an inner wall of the hollow part 12 formed in the base housing 11, and the second adhesive member 14 is coupled inside the second foreign substance groove 13.

According to an embodiment of the present invention, defect caused by foreign substance that entered from outside or generated inside can be prevented by preventing the foreign substance from approaching an image sensor, etc.

While the spirit of the present invention has been described in detail with reference to a particular embodiment, the embodiment is for illustrative purposes only and shall not limit the present invention. It is to be appreciated that those skilled in the art can change or modify the embodiment without departing from the scope and spirit of the present invention.

As such, many embodiments other than that set forth above can be found in the appended claims.

What is claimed is:

1. A camera module comprising:
a housing having a hollow part formed therein;
a lens module having a lens and installed in the hollow part of the housing in such a way that the lens module can reciprocate in a direction of an optical axis; and
a foreign substance pan coupled to the lens module and disposed to correspond to a gap formed between the housing and the lens module, foreign substance having passed through the gap being settled on the foreign substance pan.

2. The camera module of claim 1, further comprising a first adhesive member coupled to the foreign substance pan and disposed to correspond to the gap formed between the housing and the lens module.

3. The camera module of claim 1, wherein a first foreign substance groove is formed in the foreign substance pan to correspond to the gap formed between the housing and the lens module.

4. The camera module of claim 1, wherein a flange is formed in an inner wall of the hollow part of the housing to correspond to the foreign substance pan.

5. The camera module of claim 1, wherein a second foreign substance groove is formed in the housing to correspond to a gap formed between the housing and the foreign substance pan.

6. The camera module of claim 1, further comprising a second adhesive member coupled to the housing and disposed to correspond to a gap formed between the housing and the foreign substance pan.

7. The camera module of claim 1, further comprising a driver moving the lens module in the direction of the optical axis.

8. The camera module of claim 7, wherein the driver comprises a voice coil actuator or a piezo actuator.

9. The camera module of claim 1, further comprising an image sensor, the image sensor forming an image with a ray of light incident through the lens.

10. The camera module of claim 9, further comprising an infrared filter installed in the housing in such a way that the infrared filter is interposed between the image sensor and the lens module.
